(19) United States
(12) Patent Application Publication
(10) Pub. No.: US 2025/0262787 A1
(43) Pub. Date: Aug. 21, 2025

(54) FOOD PRODUCT SLICER AND ASSOCIATED SHARPENER ASSEMBLY

(71) Applicant: ILLINOIS TOOL WORKS INC., Glenview, IL (US)

(72) Inventor: Matthew W. BIRD, Xenia, OH (US)

(21) Appl. No.: 19/048,263

(22) Filed: Feb. 7, 2025

Related U.S. Application Data
(60) Provisional application No. 63/555,676, filed on Feb. 20, 2024.

(51) Int. Cl. B26D 7/12; B26D 7/22

(52) U.S. Cl. CPC B26D 7/12; B26D 7/225; B26D 2210/02

(57) ABSTRACT

A food product slicer includes a base, a knife mounted for rotation about an axis relative to the base, the knife including a peripheral cutting edge, and a carriage assembly mounted to the base for reciprocal movement back and forth past the peripheral cutting edge of the knife. A knife sharpener includes a first sharpening component movable between a first non-sharpening position spaced from the peripheral cutting edge and a first sharpening position engaged with the peripheral cutting edge. A knife guard extends about portions of the peripheral cutting edge and includes a radially inner edge facing toward and running along the peripheral cutting edge, wherein the radially inner edge includes a radially outwardly extending channel along which the first sharpening component moves to reach the first sharpening position.

### TECHNICAL FIELD

This application relates generally to food product slicers of the type commonly used to slice bulk food products and, more specifically, to a food product slicer with a rotatable slicer knife and associated knife sharpener.

### BACKGROUND

Typical reciprocating food slicers have a rotatable, circular or disc-like slicing blade, an adjustable gauge plate for varying the thickness of the slice and a carriage for supporting the food as it is moved back and forth past the cutting edge of the knife, and over a knife cover plate, during slicing. A drive motor may be linked to drive the carriage back and forth during an automatic slicing operation carried out by a controller of the slicer. The gauge plate is situated along the edge of the knife toward the front of a slicing stroke and is laterally movable with respect to the knife for varying the thickness of the slices to be cut. A rotatable adjustment or indexing knob is provided manually for setting a spacing between the plane of the gauge plate surface and the plane of the knife edge for the purpose of slicing so that operators can select a thickness of slices to be produced.

Slicers knives, by nature, need to be sharpened in order to maintain a long-life and proper slicer performance. For the purpose of sharpening, a sharpening stone is brought into contact with the knife edge (typically at both the back and front sides of the knife). Limiting exposure of the knife edge is also preferred. U.S. Pat. No. 7,134,937 discloses a slicer with a sharpener and associated knife guard in which a guard member pivots between a cutting edge guard position and a cutting edge sharpening position in which sharpening stones can contact the knife edge for sharpening. Movement of the pivoting guard member is triggered by actuation of the sharpener assembly.

It would be desirable to provide a slicer with an effective knife sharpener that has more limited exposure of the knife edge, especially during sharpening.

### SUMMARY

In one aspect, a food product slicer includes a base, a knife mounted for rotation about an axis relative to the base, the knife including a peripheral cutting edge, and a carriage assembly mounted to the base for reciprocal movement back and forth past the peripheral cutting edge of the knife. A knife sharpener includes a first sharpening component movable between a first non-sharpening position spaced from the peripheral cutting edge and a first sharpening position engaged with the peripheral cutting edge. A knife guard extends about portions of the peripheral cutting edge and includes a radially inner edge facing toward and running along the peripheral cutting edge, wherein the radially inner edge includes a radially outwardly extending channel along which the first sharpening component moves to reach the first sharpening position.

In another aspect, a food product slicer includes a base, a knife mounted for rotation about an axis relative to the base via a knife drive shaft, the knife including a peripheral cutting edge, a knife sharpener including a sharpening stone movable between a non-sharpening position spaced from the knife edge and a sharpening position engaged with the knife edge, and a knife guard extending about portions of the peripheral cutting edge, where the knife guard includes a radially outward extending recess along which the sharpening stone moves to reach the sharpening position.

In yet another aspect, a food product slicer includes a base, a knife mounted for rotation about an axis relative to the base, the knife including a peripheral cutting edge, wherein the peripheral cutting edge defines a cutting edge plane and a carriage assembly mounted to the base for reciprocal movement back and forth past the peripheral cutting edge of the knife. A knife sharpener includes a first sharpening component and a second sharpening component, the first sharpening component movable between a first non-sharpening position spaced from the peripheral cutting edge and a first sharpening position engaged with the peripheral cutting edge in a first region of a knife perimeter defined by the peripheral cutting edge, the second peripheral component movable between a second non-sharpening position spaced from the peripheral cutting edge and a second sharpening position engaged with the peripheral cutting edge in a second region of the knife perimeter. A knife guard rail extends about portions of the peripheral cutting edge, the knife guard rail including a radially inner edge facing toward and running along the peripheral cutting edge in both the first region and the second region. When the first sharpening component is in the first sharpening position and the second sharpening component is in the second sharpening position, the peripheral cutting edge in both the first region of the knife perimeter and the second region if the knife perimeter is radially bounded, in the cutting edge plane, by the radially inner edge of the knife guard rail.

In another aspect, a food product slicer includes a base, a knife mounted for rotation about an axis relative to the base via a knife drive shaft, the knife including a peripheral cutting edge, a knife sharpener including a sharpening stone movable between a non-sharpening position spaced from the knife edge and a sharpening position engaged with the knife edge, and a knife guard rail having a first end and a second end, and extending about a portion of the peripheral cutting edge. The knife guard rail is configured with a face portion that faces in a first direction parallel the axis of the knife and toward a carriage side or upper side of the knife, and an entirety of the portion of the peripheral cutting edge bounded by the knife guard rail between the first end and the second end is offset from the face portion in a second direction parallel to the axis and toward a slice drop side or lower side of the knife.

### BRIEF DESCRIPTION OF DRAWINGS

FIGS. 1-4 show perspective views of a food product slicer;

FIGS. 5-6 show perspective views of portions of the slicer;

FIGS. 7-8 show portions of a mount component that includes a knife guard;

FIGS. 9-10 show perspective views of a region of the knife guard that facilitates knife sharpening;

FIGS. 11-16 show a sharpener assembly with sharpening and truing stones in non-sharpening positions, (FIG. 11 with sharpener cover shown, and FIGS. 12-16 with cover not shown);

FIGS. 17-18 show cross-section views of a first one of the sharpening components in the non-sharpening position;

FIGS. 19-20 show cross-section views of the first one of the sharpening components in the sharpening position;

FIG. 21 shows a perspective view of a second one of the sharpening stones in the sharpening position; and

FIGS. 22-23 show cross-section views of the second one of the sharpening stones in the sharpening position.

### DETAILED DESCRIPTION

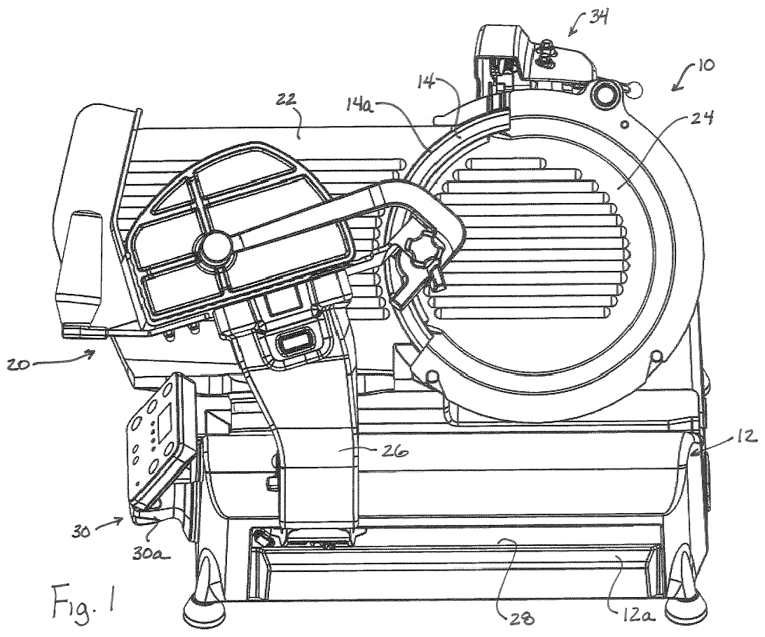

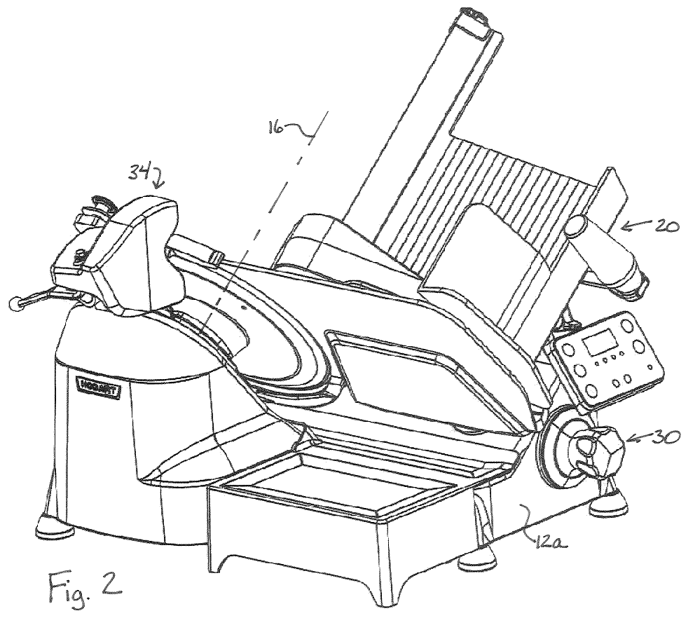

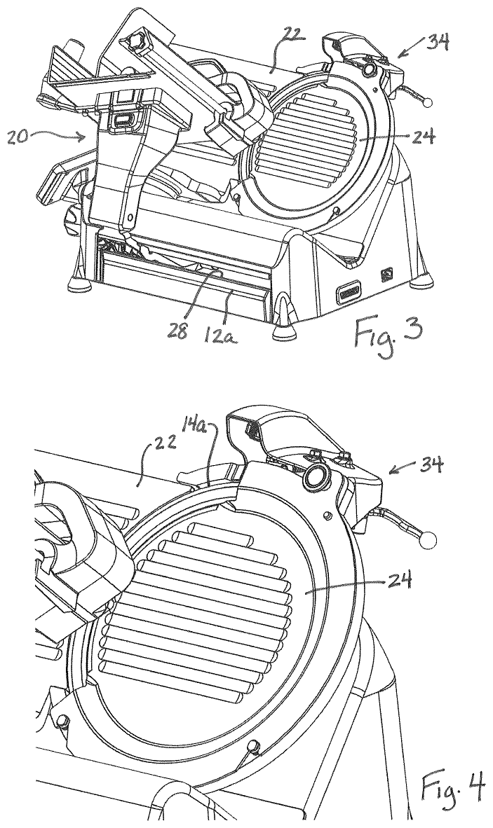

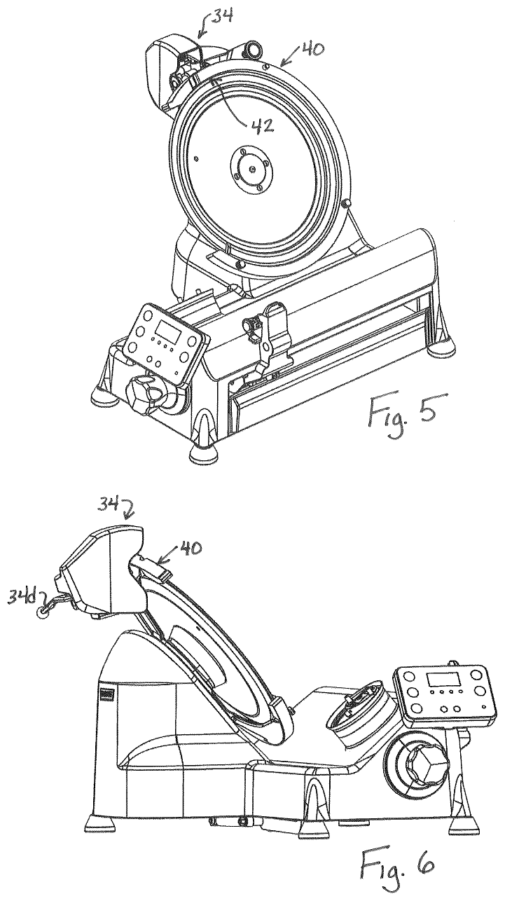

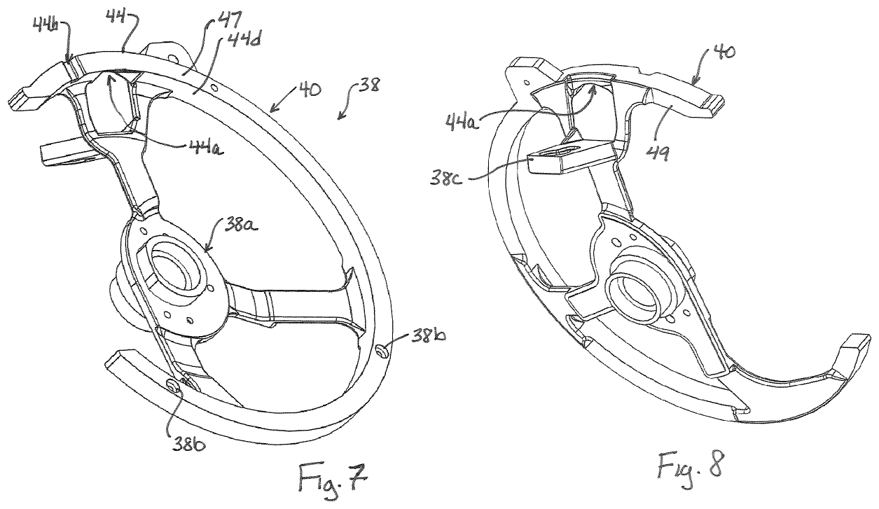

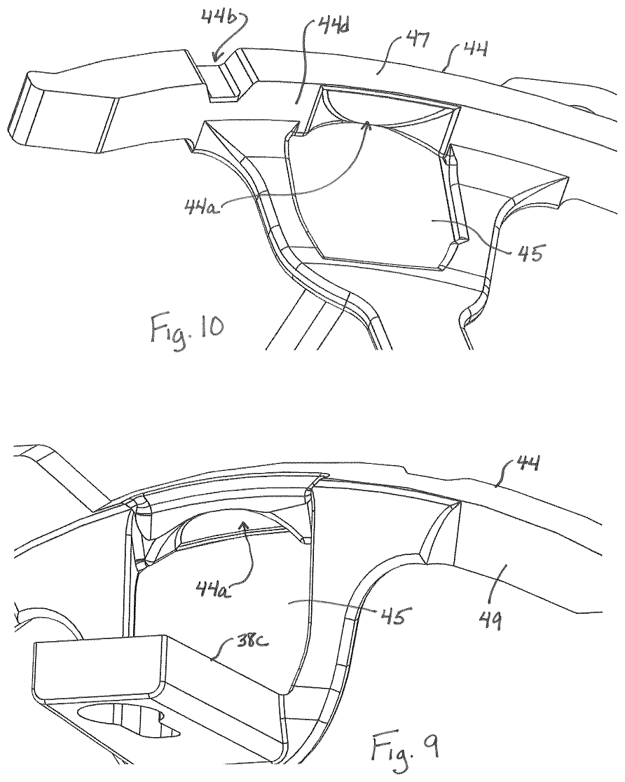

Referring to FIGS. 1-4, a food product slicer 10 includes a base 12 and a circular, motor-driven slicing knife 14 that is mounted to the housing for rotation about an axis 16. The left side of FIG. 1, where the controls are located and an operator is located during slicing, is generally referred to as the front side of the slicer (which is where an operator stands for slicing), and the right side of FIG. 1 is generally referred to as the rear side of the slicer. A food product can be supported on a manually operable (or motor driven) food carriage 20 which moves the food product to be sliced past the peripheral cutting edge 14a of the rotating slicing knife 14. The food carriage 20 reciprocates from left to right relative to FIG. 1, along a linear carriage path so that the lower end of the bulk food product slides along the surface of a gauge plate 22, is cut by the knife 14 and then slides along a knife cover plate 24. Food carriage 20 includes a tray mounted on a tray arm 26 that orients the food carriage tray at the appropriate angle (typically perpendicular) to the knife cutting-edge plane. The food carriage arm reciprocates in a slot 28 at a lower portion of an external housing 12a of the base 12. The carriage 20 can be moved manually (e.g., by a handle) and/or the carriage 20 may also be automatically driven (e.g., as by an internal motor that drives a belt that is linked internally to the arm). A gauge plate system includes a rotatable knob 30 (connected to an opening in the base 12) that includes a grip part 30a and an internal cam part that is linked to the gauge plate 22 such that rotation of the knob 30 effects movement the gauge plate, relative to a plane of the knife edge 14a, to adjust slice thickness. Generally, during movement of the gauge plate 22, the food product contact surface plane of the gauge plate 22 remains substantially parallel to the plane of the knife edge 14a. A knife sharpener assembly 34 is also mounted on the machine and can be manually operated to sharpen the knife edge 14a.

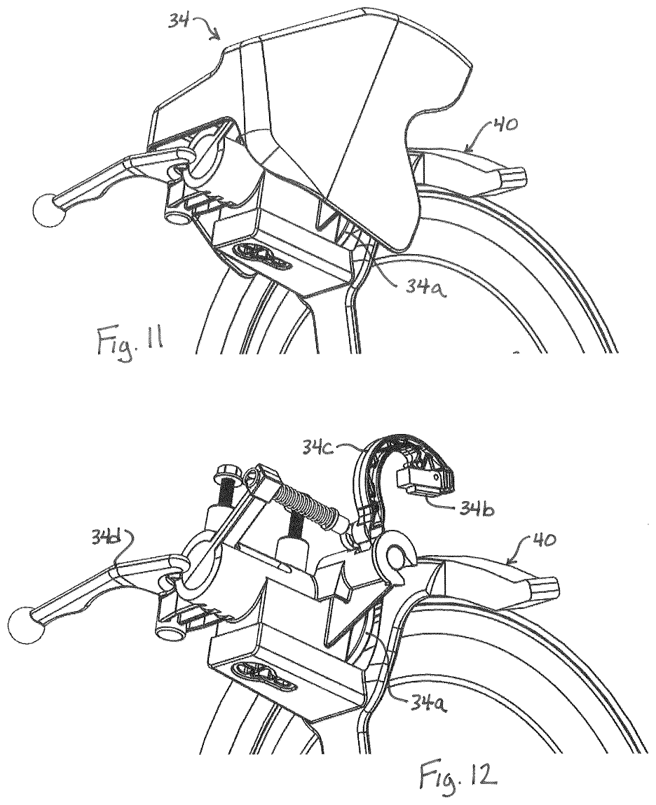

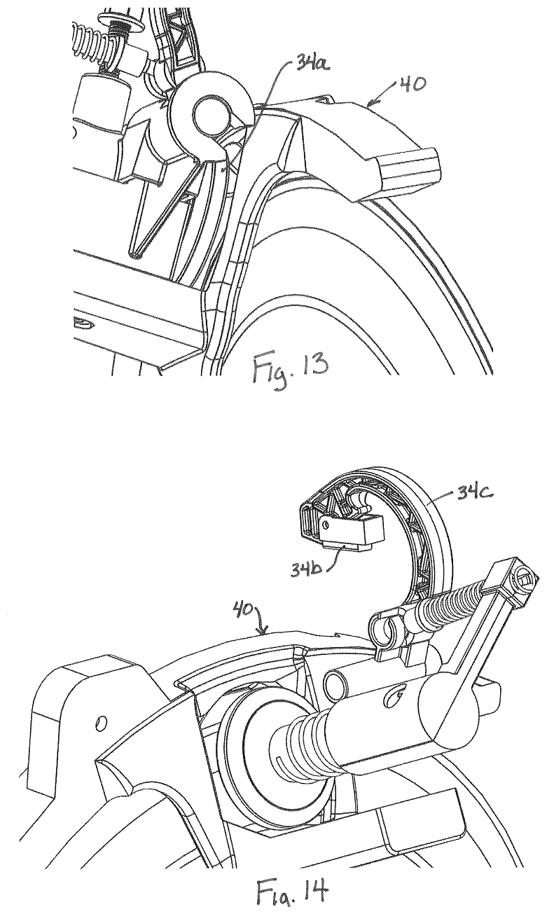

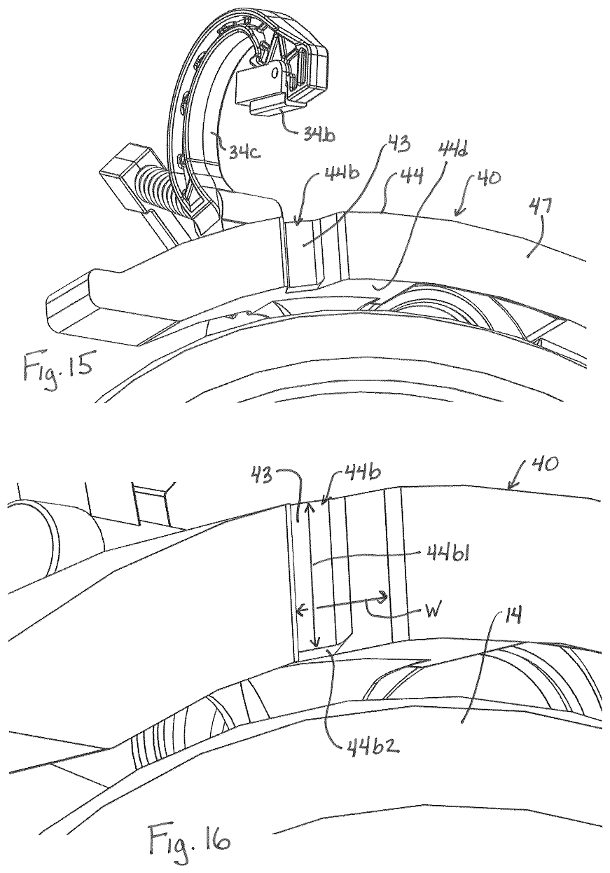

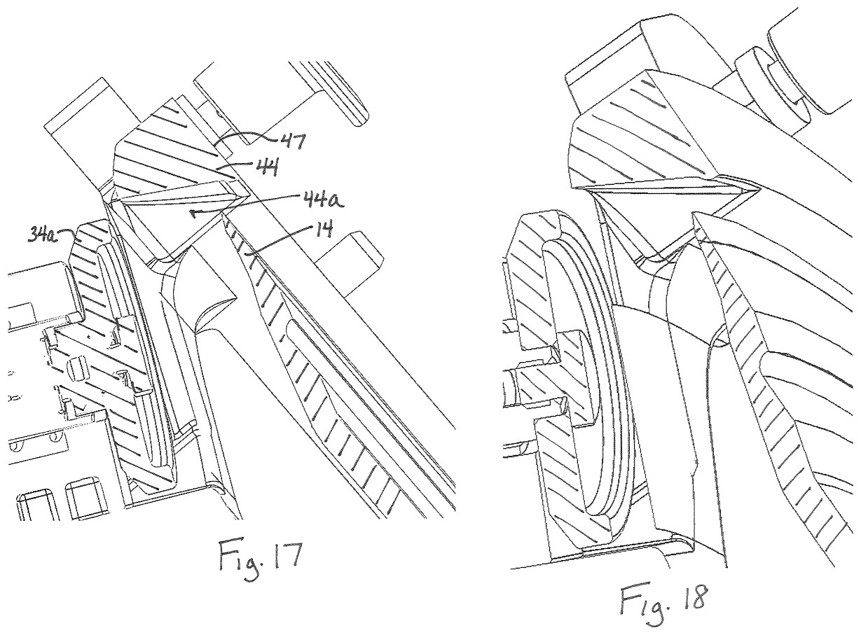

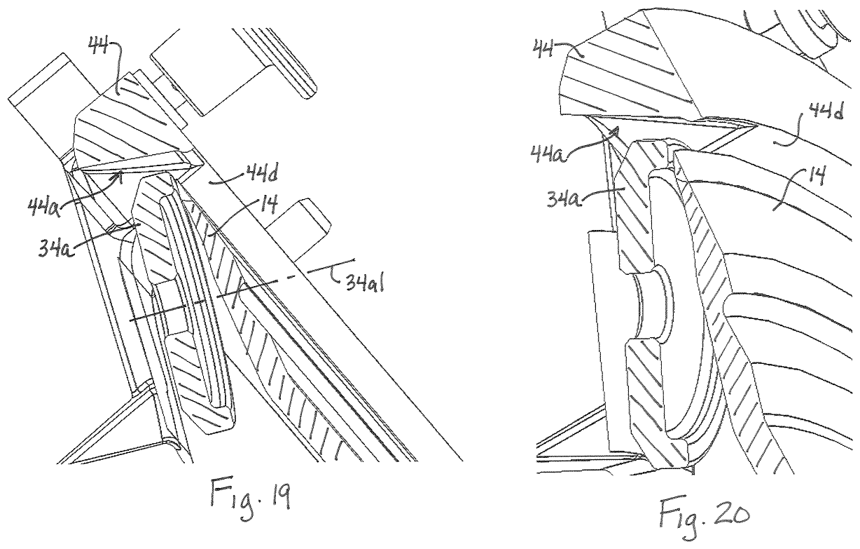

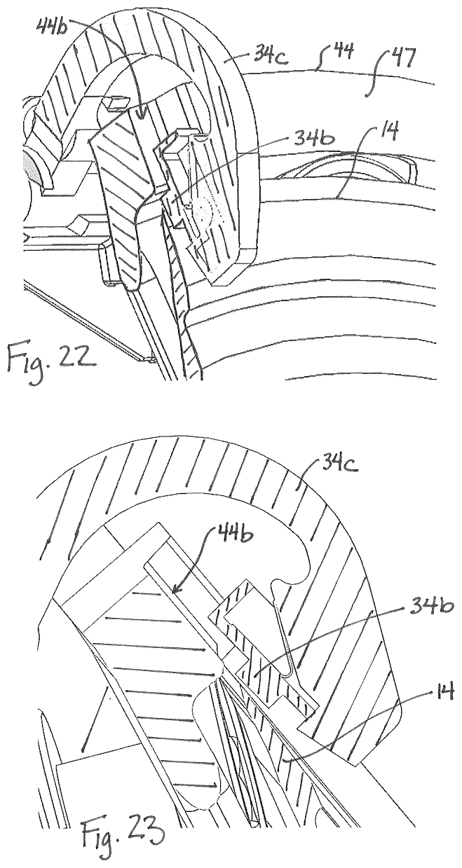

In this regard, referring to FIGS. 5-23, the slicer includes a knife guard 40 that extends about portions of the knife edge, including in a region 42 of the knife sharpener assembly 34. Here, the sharpener assembly 34 includes an axially movable sharpening stone 34a (or other) and a truing stone 34b (or other) mounted on a pivotable arm 34c, with both stones movable, by operation of a control arm 34d, between non-sharpening positions (per FIGS. 13-18) and sharpening positions in which they engage the knife edge (per FIGS. 19-23). The movement of the stones may be similar to that described in U.S. Pat. No. 5,591,072.

The knife guard 40 comprises a peripheral rail 44 that is configured to both guard the knife peripheral cutting edge 14a and permit the sharpening and truing stones to engage with the knife peripheral cutting edge 14a during sharpening. More specifically, the rail 44 includes a radially outward extending channel 44a through or along which the stone 34a is movable to reach a first side of the knife peripheral cutting edge, and a slot recess 44b, formed in a cover plate facing side or face portion 47 of the rail, and into which portions of the structure holding the stone 34b (and potentially portions of the stone 34b itself) move to allow the stone 34b to engage with a second side of the knife peripheral cutting edge. Here, the channel 44a has a shape (e.g., substantially cylindrical) that follows the peripheral contour of the stone 34a (e.g., stone is circular), while the slot recess 44b is more rectangular in shape.

When the stones 34a, 34b are in the non-sharpening positions, the knife guard rail 44 is configured such that there is little or no exposure of the knife peripheral cutting edge. A peripheral portion of the knife cover plate 24 overlaps with the region of the location of channel 44a at the second side of the knife peripheral cutting edge. When the stone 34a is in the non-sharpening position, the stone 34a is located proximate an entry end of the channel 44a at the first side of the knife peripheral cutting edge (per FIG. 13). This overall configuration blocks access to the knife peripheral cutting edge along the channel 44a. The slot recess 44b includes a major portion 44b1 that extends radially and is offset from the knife peripheral cutting edge, and only a radially inner portion 44b2 is deep enough to provide the stone 34b access to the knife peripheral cutting edge 14a. This provides a configuration in which the entire knife peripheral cutting edge, at least in the regions of sharpening stone contact, and more desirably in the entire region extending from one end of the rail 44 to the opposite end of the rail 44, is offset (e.g., in a direction along the knife axis and toward the slice drop side/lower side of the knife) back from a plane in which the side or face portion 47 of the ring guard rail 44 lies, but the knife is still able to sharpened.

In embodiments, an entirety of the portion of the peripheral cutting edge that is bounded by the knife guard rail between the two ends of the rail, inclusive of edge portions in the region of the slots 44a and 44b, is aligned with and positioned radially inward of part of the radially inwardly facing edge 44d of the rail 44 so to provide only a very small radial gap between the radially inward facing edge 44d and the peripheral cutting edge 14a. This limits undesired exposure of the knife peripheral cutting edge 14a.

Movement of the knife guard rail 44 is not needed and does not take place to achieve sharpening. In the sharpening position of the stones 34a, 34b, the upper portion of the stone 34a, which upper portion is, here, above the rotation axis 34a1 of the stone 34a, engages with the knife edge 14a, and the stone 34a is also covered by the rail 44. Only a small portion of the stone 34b moves into the radially inner portion 44b2 of the slot recess 44b. Positioning of the stone 34a such that the upper portion 34a will engage the knife edge for sharpening is particularly useful for limiting knife edge exposure.

As explained above, the geometry of the ring guard is also important. Just enough tolerance for sharpener functionality is provided, while still covering the knife edge as much as possible. The depicted geometry will safeguard the knife while still allowing the sharpener to sharpen the knife.

Here, the knife guard 40 may be part of a single monolithic mount part 38 that is provided to serve as both the part to which a drive shaft assembly for the knife 14 mounts (e.g., per hub 38a), the part to which the knife cover plate 24 mounts (e.g., per openings 38b) and the part to which the knife sharpener assembly 34 mounts (e.g., per sharpener mount platform 38c). This also helps assure proper positioning and tolerance between the knife guard 40 and the knife edge 14a, as well as the sharpening stones.

Here, the channel 44a is formed at the upper side of an opening 45 through the mount part 38, such that the sharpening stone 34a passes along and/or through an opening that is fully enclosed or surrounded by portions of the mount component, to reach the knife peripheral cutting edge. The opening 45 therefore operates as a tunnel through which the stone 34a passes. Notably, the sharpener mount platform 38c extends from a region below the opening 45.

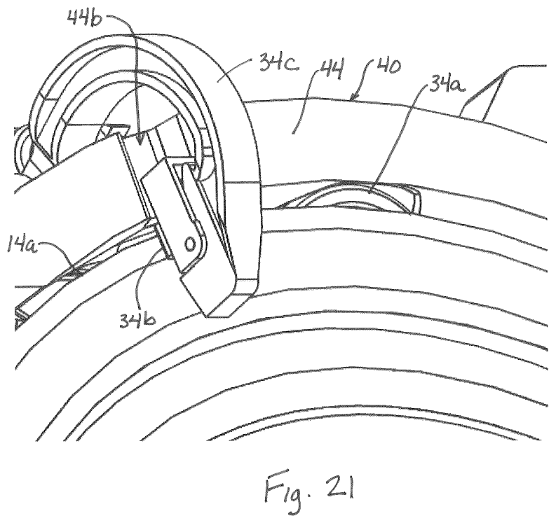

Thus, the described embodiment provides a food slicer 10 with a knife sharpener 34 including a first sharpening component 34a movable between a first non-sharpening position (FIGS. 17-18) spaced from the knife peripheral cutting edge 14a and a first sharpening position (FIGS. 19-20) engaged with the peripheral cutting edge. The knife guard 40 extends about portions of the peripheral cutting edge 14a, and the knife guard 40 includes a radially inner edge 44d facing toward and running along the peripheral cutting edge 14a. The radially inner edge 44d includes a radially outwardly extending channel 44a along which the first sharpening component 34a moves to reach the first sharpening position. The knife guard includes a front face 47 and a rear face 49, wherein the front face 47 faces the carriage assembly movement path. The channel 44a includes an entry end toward the rear face 49 and a closed end covered by the front face 47.

The peripheral cutting edge 14a of the knife defines a cutting edge plane, the front face 47 defines a knife guard plane, and the cutting edge plane is offset from the knife guard plane in a direction toward the rear face 49 (see FIG. 17). The sharpener 34 includes a second sharpening component 34b movable between a second non-sharpening position (FIG. 15) spaced from the peripheral cutting edge and a second sharpening position (FIGS. 21-23) in which the second sharpening component 34b is engaged with the peripheral cutting edge 14a. The front face 47 of the knife guard includes a slot recess 44b into which at least part of the second sharpening component 34b is located when the second sharpening component is in the second sharpening position. The slot recess 44b includes a bottom wall 43 with a radially outer major portion 44b1 having a first depth and lying in a slot plane, wherein the peripheral cutting edge plane is aligned with the slot plane or is offset from the slot plane in the direction toward the rear face 49. The bottom wall 45 includes a radially inner minor portion 44b2 that tapers away from the bottom wall 45 and the knife guard plane and in a direction toward the radially inner edge 44d of the knife guard.

When moving from the non-sharpening position to the sharpening position, the first sharpening component 34a moves along a through opening 45 of the knife guard, wherein the channel 44a is part of a boundary defining the through opening, and the boundary fully surrounds the through opening 45. Here, the channel 44a is formed by a portion of a peripherally enclosed opening 45 through a mount part 38 that includes the knife guard 40.

The knife guard rail 44 extends about portions of the peripheral cutting edge 14a, and the knife guard rail 44 includes a radially inner edge 44d facing toward and running along the peripheral cutting edge 44a in both a first region where the first sharpening component 34a contacts the knife for sharpening and a second region where the second sharpening component 34b contacts the knife for sharpening. When the first sharpening component 34a is in the first sharpening position and the second sharpening component 34b is in the second sharpening position, the peripheral cutting edge 14a in both the first region of the knife perimeter and the second region if the knife perimeter is radially bounded, in the cutting edge plane, by the radially inner edge 44d of the knife guard rail 44. The knife guard rail 44 is mounted in a fixed position and does not move when the first and second sharpening components 34a and 34b move from the first and second non-sharpening positions into the first and second sharpening positions.

Here, a radial gap between the peripheral cutting edge 14a of the knife 14 and the radially inner edge 44d of knife guard rail may be between 0.5 mm and 5 mm (e.g., less than 5 mm or less than 4 mm), and the width W of the slot recess 44b may be between 5 mm and 50 mm (e.g., less than 50 mm or less than 45 mm, less than 40 mm or less than 35 mm). However, variations are possible.

Overall, the described configuration provides for easy cleaning, assures that the knife edge is not significantly exposed (normally or during sharpening), requires a limited part count, and employs a knife guard that does not have parts that must move in order to sharpen the knife.

It is to be clearly understood that the above description is intended by way of illustration and example only and is not intended to be taken by way of limitation. Variations are possible.

1. A food product slicer, comprising:
a base;
a knife mounted for rotation about an axis relative to the base, the knife including a peripheral cutting edge;
a carriage assembly mounted to the base for reciprocal movement back and forth past the peripheral cutting edge of the knife;
a knife sharpener including a first sharpening component movable between a first non-sharpening position spaced from the peripheral cutting edge and a first sharpening position engaged with the peripheral cutting edge;
a knife guard extending about portions of the peripheral cutting edge, the knife guard including a radially inner edge facing toward and running along the peripheral cutting edge, wherein the radially inner edge includes a radially outwardly extending channel along which the first sharpening component moves to reach the first sharpening position.

2. The food product slicer of claim 1, wherein the knife guard includes a front face and a rear face, wherein the front face faces a carriage assembly movement path, wherein the channel includes an entry end toward the rear face and a closed end covered by the front face.

3. The food product slicer of claim 2, wherein the peripheral cutting edge defines a cutting edge plane, wherein the front face defines a knife guard plane, and the cutting edge plane is offset from the knife guard plane in a direction toward the rear face.

4. The food product slicer of claim 3, wherein the sharpener includes a second sharpening component movable between a second non-sharpening position spaced from the peripheral cutting edge and a second sharpening position in which the second sharpening component is engaged with the peripheral cutting edge, wherein the front face of the knife guard includes a slot recess into which at least part of the second sharpening component is located when the second sharpening component is in the second sharpening position.

5. The food product slicer of claim 4, wherein the slot recess includes a bottom wall with a radially outer major portion having a first depth and lying in a slot plane, wherein the peripheral cutting edge plane is aligned with the slot plane or is offset from the slot plane in the direction toward the rear face.

6. The food product slicer of claim 5, wherein the bottom wall includes a radially inner minor portion that tapers away from the bottom wall and the knife guard plane and in a direction toward the radially inner edge of the knife guard.

7. The food product slicer of claim 1, wherein, when moving from the non-sharpening position to the sharpening position, the first sharpening component moves along a through opening of the knife guard, wherein the channel is part of a boundary defining the through opening, and the boundary fully surrounds the through opening.

8. The food product slicer of claim 1, wherein the channel is formed by a portion of a peripherally enclosed opening through a mount part that includes the knife guard.

9. A food product slicer, comprising:
a base;
a knife mounted for rotation about an axis relative to the base, the knife including a peripheral cutting edge, wherein the peripheral cutting edge defines a cutting edge plane;
a carriage assembly mounted to the base for reciprocal movement back and forth past the peripheral cutting edge of the knife;
a knife sharpener including a first sharpening component and a second sharpening component, the first sharpening component movable between a first non-sharpening position spaced from the peripheral cutting edge and a first sharpening position engaged with the peripheral cutting edge in a first region of a knife perimeter defined by the peripheral cutting edge, the second peripheral component movable between a second non-sharpening position spaced from the peripheral cutting edge and a second sharpening position engaged with the peripheral cutting edge in a second region of the knife perimeter;
a knife guard rail extending about portions of the peripheral cutting edge, the knife guard rail including a radially inner edge facing toward and running along the peripheral cutting edge in both the first region and the second region, wherein, when the first sharpening component is in the first sharpening position and the second sharpening component is in the second sharpening position, the peripheral cutting edge in both the first region of the knife perimeter and the second region if the knife perimeter is radially bounded, in the cutting edge plane, by the radially inner edge of the knife guard rail.

10. The food product slicer of claim 9, wherein the knife guard rail is mounted in a fixed position and does not move when the first and second sharpening components move from the first and second non-sharpening positions into the first and second sharpening positions.

11. The food product slicer of claim 10, wherein the knife guard rail is part of a mount part that defines a peripherally enclosed opening through which the first sharpening component moves to reach the first sharpening position.

12. The food product slicer of claim 10, wherein the knife guard rail includes a front face and a rear face, wherein the front face faces a carriage assembly movement path, wherein the front face defines a knife guard plane, and the cutting edge plane is offset from the knife guard plane in a direction toward the rear face.

13. A food product slicer, comprising:
a base;
a knife mounted for rotation about an axis relative to the base, the knife including a peripheral cutting edge;
a knife sharpener including a sharpening stone movable between a non-sharpening position spaced from the peripheral cutting edge and a sharpening position engaged with the peripheral cutting edge;
a knife guard rail having a first end and a second end, and extending about a portion of the peripheral cutting edge, wherein the knife guard rail is configured with a face portion that faces in a first direction parallel the axis of the knife and toward a carriage side of the knife, and an entirety of the portion of the peripheral cutting edge bounded by the knife guard rail between the first end and the second end is offset from the face portion in a second direction parallel to the axis and toward a slice drop side of the knife.
